(19) United States
(12) Patent Application Publication
(10) Pub. No.: US 2011/0008637 A1
(43) Pub. Date: Jan. 13, 2011

(54) METHOD FOR IMPROVING THE PERFORMANCE OF OPTICAL BRIGHTENING AGENTS

(76) Inventors: Katherine M. Broadus, Aurora, IL (US); Xiaojin Harry Li, Palatine, IL (US); Prasad Y. Duggirala, Naperville, IL (US)

Correspondence Address: Benjamin E. Carlsen;Nalco Company, Patent and Licensing Department, 1601 West Diehl Road, Naperville, IL, 60563-1198, US

(21) Appl. No.: 12/499,916

(22) Filed: Jul. 9, 2009

(51) Int. Cl. B32B 29/00

(52) U.S. Cl. 428/537.5

(57) ABSTRACT

The invention provides a more effective optical brightener composition for coating paper substrates. The invention includes an optical brightening agent (OBA) and a glycerol based polymer. This combination results in a composition that provides a surprisingly large whitening effect and does not degrade the shade of the paper. As a result extremely high degrees of whiteness can be achieved without being frustrated by the greening effect.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates to optical brightening agents (OBAs) and their use. OBAs (which are also sometimes referred to as fluorescent whitening agents or FWAs) are used to enhance the optical properties of the substrates (in particular paper) that they coat. OBAs are widely used in papermaking and paper coating processes to increase the whiteness and brightness of produced paper. OBAs that are water-soluble are particularly useful because they are easy to apply and store.

Prior art paper coatings typically comprise a number of ingredients. 50-65% solids (by weight) of the coating are often solid materials. The largest component of these solids, are particulates such as calcium carbonate. Other particulates used in these coatings include titanium dioxide and alumina trihydrate (ATH). In addition, polymeric binders are used, at levels of 10-15 parts per hundred (pph) by weight relative to the weight of the particulate. These binders help to both adhere pigment to the paper substrate and to help bind the pigment particles to each other. Typical binders include starch or latex polymers. Paper coating formulations also often include a co-binder, which improves the rheology and water retention of the formulation, and thereby the overall manufacturing process of the produced paper. Used co-binders include polyvinyl alcohol (PVOH), carboxymethyl cellulose, soy protein, starch, and sodium alginate. Other ingredients of coatings include dispersants, cross-linking reagents (also called insolubizers), biological control reagents, and OBAs. OBAs improve the optical properties of these coatings.

OBA containing coatings improve various optical properties including brightness, whiteness, and shade of the paper they coat. OBA containing coatings achieve these properties by using fluorescent dyes and/or pigments that absorb invisible ultraviolet radiation (approximately in the 300 nm-400 nm wavelength range) and emit in the violet to blue region of the spectrum (approximately in the 400 nm to 500 nm wavelength range). The efficiency of this process is influenced by a number of factors.

The molecular size of the OBA can also affect its brightness contribution because low molecular weight OBAs tend to migrate out of the coating and into the substrate, thereby losing their effectiveness. In addition the “greening effect”, the tendency of high concentrations of OBAs to aggregate into insoluble masses that do not increase brightness, limits how much OBA can be added to an OBA containing coating. While co-binders are used to counteract the greening effect, these co-binders are often expensive and therefore less than desirable.

Additional pigments are sometimes used in OBA containing coatings and can affect the overall brightness. Additional calcium carbonate pigment provides an ISO brightness of 96-98%, titanium dioxide 98-99%, and ATH 98-100%. Additional clay pigment provides less brightness and therefore is used in lower grades of paper

Thus there is a clear need and utility for an improved OBA containing coating for use with paper substrates. The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. §1.56(a) exists.

### BRIEF SUMMARY OF THE INVENTION

At least one embodiment of the invention is directed towards a method for increasing the brightness and/or whiteness of an OBA containing coating of a paper substrate. The method comprises the step of: applying to a paper substrate a composition, the composition comprising: at least one glycerol based polymer and at least one OBA. The OBA can be selected from but not limited to the list consisting of: tetrasulfonated stilbene dyes or pigments, hexasulfonated stilbene dyes or pigments, disulfonated stilbene dyes or pigments, distryl biphenyl dyes or pigments, other dyes or pigments applicable for this method and any combination thereof. The glycerol based polymer can be selected from but not limited to the list consisting of: polyglycerols, polyglycerol derivatives, a polymer consisting of glycerol monomer units and at least another monomer units to other multiple monomers units, and any combination thereof. The glycerol based polymer has a structure selected from but not limited to the list consisting of: linear, branched, hyperbranched, dendrimeric, cyclic and any combination thereof.

At least one embodiment of the invention is directed towards a method for increasing the brightness and/or whiteness produced by an OBA in which the inventive glycerol based polymer comprises an amount that is equal to 1 to 10 pph relative to the weight of the solid portion of the coating formulation. The glycerol based polymer can have a molecular weight range of between 1,000 and 15,000 Daltons or even higher. The substrate applied by the composition can have a density of between 20-200 g/m². The applied composition can have a density of between 2-80 g/m².

At least one embodiment of the invention is directed towards a method for increasing the brightness and whiteness by an OBA in which the inventive composition further comprises one item selected from the list consisting of: water, solvent, organic acids or the salt forms, carboxymethyl cellulose, soy protein, starch, sodium alginate, SBA, PVOH, acid function group based polymers (described in US 2003/0144408 A1), nonionic polysaccharides, polyalkene derivatives of stilbene, precipitated calcium carbonate (PCC), ground calcium carbonate (GCC), sizing agent, titanium dioxide, ATH, clay, dispersants, cross-linking reagents, biological control reagents, and any combination thereof. The composition can comprise an OBA that is present in an amount equal to 0.1-6 pph of the solid portion of the coating formulation.

### DETAILED DESCRIPTION OF THE INVENTION

For purposes of this application the definition of these terms is as follows:

“Binder” means a composition of matter within a coating formulation that helps to both adhere pigment to the paper substrate and to help bind pigment particles to each other

“Brightness” means a measurement of the ability of a sample to reflect monochromatic (457 nm) light as compared to a known standard, using magnesium oxide (MgO). Brightness is a term used to describe the whiteness of pulp or paper, on a scale from 0% (absolute black) to 100% (relative to a MgO standard, which has an absolute brightness of about 96%) by the reflectance of blue light (475 nm) from the paper.

“Co-binder” means a constituent of an OBA coating which is present in small amount, less than 10 pph relative to the particulate weight, and is used for the purpose of improving some aspect of the coating formulation or final coated product.

“Dye” means a material used in an OBA containing coating formulation to alter the optical properties of a substrate.

“Glycerol based polymers” means any polymers containing glycerol monomer units such as polyglycerols, polyglycerol derivatives, and a polymer consisting of glycerol monomer units and at least another monomer units to other multiple monomers units. “Glycerol” in the “glycerol based polymers” means any glycerol based monomers which can be polymerized into plyglycerols with or without additional steps before or after the polymerization such as glycerol, glycidol, glycerol carbonate and chlorohyrins.

“OBA” means a dye or pigment based optical brightening agent which is a component of a coating formulation commonly applied to a paper substrate. Fluorescent dyes or pigments that absorb ultraviolet radiation and reemit it at a higher frequency in the visible spectrum (blue), thereby effecting a white, bright appearance.

“Particulates” means a finely ground solid powder that may or may not be water-soluble.

“Pigment” means a solid material used in an OBA containing coating formulation to alter the optical properties of a substrate.

“Pulp” means the fibrous raw materials used to make paper, the fibrous raw materials are usually of vegetable origin, are commonly cellulose fibers, are commonly wood based, but may be synthetic or of other origin, and may contain pieces of wood.

“Solvent” means a liquid medium used to facilitate transfer of particles, the particles may or may not be dissolved in the liquid medium.

“Substrate” means a sheet of paper, a sheet of paper precursor, a mass of fibers, or any other material that can be or has been treated by the inventive OBA containing coating.

“Whiteness” means a measurement of the CIE (Commission of Internationale de l'Eclairage) whiteness of a sample as derived from the CIE tristimulus values, corresponding to the CIE 1964 standard observer and the CIE illuminant D65.

In the event that the above definitions or a definition stated elsewhere in this application is inconsistent with a meaning (explicit or implicit) which is commonly used, in a dictionary, or stated in a source incorporated by reference into this application, the application and the claim terms in particular are understood to be construed according to the definition in this application, and not according to the common definition, dictionary definition, or the definition that was incorporated by reference.

In at least one embodiment of the invention, a paper substrate is coated with an OBA containing coating that improves its optical properties. In at least one embodiment, the coating comprises at least one stilbene based OBA such as tetrasulfonated diamino stilbene. The coating also contains a glycerol based polymer. In at least one embodiment the coating also comprises water and/or a solvent. Diamino stilbene OBAs are often classified by the number of sulfonated groups on the molecule. The commonly used materials are either disulfonated, tetrasulfonated, and hexasulfonated. The tetrasulfonated derivative is usually the least expensive and preferred among papermakers. Tetrasulfonated derivatives however are limited in the maximum dosage allowable due to the undesirable greening effect. Stilbene's use as a dye or pigment is described for example in U.S. Pat. No. Prior 5,885,340.

Without being limited to theory it is believed that the glycerol based polymer promotes the formation of a structure that enhances the effectiveness of the stilbene OBA dye or pigment. U.S. Pat. No. 6,133,215 describes how polyglycerol combined with distryl biphenyl molecules form an enhanced complex and it is believed that a similar mechanism is at work when the glycerol based polymer is combined with tetrasulfonated diamino stilbene. For optimal performance, OBAs need to maintain a planar and trans configuration of the olefin moiety in the stilbene structure. It is believed that the glycerol base polymer promotes this preferred configuration of the OBA through hydrogen bonding. In addition, glycerol based polymers serve to reduce the migration of OBAs into the base sheet and thus provide enhanced brightness and whiteness attributes.

In at least one embodiment the OBA containing coating further comprises at least one item selected from the list consisting of: styrene-butyl acrylonitrile latex (SBA), calcium carbonate, organic acids or the salts forms, polyvinyl alcohol, starch, acid functional group based polymers, nonionic polysaccharides, polyalkene derivatives of stilbene, and any combination thereof. In at least one embodiment the OBA containing coating is formulated and used in the manner described in U.S. Pat. Nos. 5,057,570, 6,030,443, Published US Patent Application 2003/144408, and International Application WO 2006 033321. In at least one embodiment, the calcium carbonate is GCC (ground calcium carbonate derived from natural rock/not synthesized).

In at least one embodiment, the molecular weight of the glycerol based polymers are 1000-15,000 Daltons or even higher. In at least one embodiment, the molecular weight of the glycerol based polymer is 1000-6,000 Daltons.

When a paper substrate is coated with an OBA containing layer, the coating must improve the optical properties of the paper, it must not unduly impair the strength of the resulting paper. In at least one embodiment this is facilitated by having the paper substrate have a density of 20-200 g/m² and the OBA coating on each side is 2-80 g/m². The coating can be applied by any number of methods including but not limited to a metered size press, a rod and a blade or air coater.

### EXAMPLES

The following examples are presented to describe embodiments and utilities of the invention and are not meant to limit the invention unless otherwise stated in the claims.

Eighteen samples were prepared to compare the optical properties of various OBA formulations. The samples were applied to one-side of a wood-free base sheet substrate (70 g/m²), such the dried coating composition was 13 g/m². The coatings contained tetrasulfonated diamino stilbene or hexasulfonated stilbene OBAs. The coatings contained 64% solid. The solids of the control sample contained GCC and 10 parts per hundred SBA. A PVOH bearing sample contained GCC and 9 parts per hundred SBA, and 1 pph PVOH (Mowiol Type 4-98, by Kuraray Europe Gmb). A glycerol based polymer bearing solution contained 9 pph SBA and 4 pph a glycerol based polymer. The OBA was dosed on a product basis in the range of 1-4 pph. Table 1 illustrates that the polyglycerol based samples resulted in the best brightness, superior whiteness, and a more preferred red shade (as indicated by the larger a* value).

TABLE 1

| Sample | | | | | | |
|---|---|---|---|---|---|---|
| Number | Coating Solution | Brightness | Whiteness | L* | a* | b* |
| 1 | Control, 1 pph tetra OBA | 95.7 | 103.8 | 96.6 | 0.54 | −2.77 |
| 2 | Control, 2 pph tetra OBA | 96.6 | 105.4 | 96.7 | 0.35 | −3.05 |
| 3 | Control, 4 pph tetra OBA | 95.4 | 99.9 | 96.8 | −0.43 | −1.79 |
| 4 | PVOH, 1 pph tetra OBA | 100.2 | 117.6 | 96.8 | 1.43 | −5.79 |
| 5 | PVOH, 2 pph tetra OBA | 100.8 | 116.9 | 97.0 | 0.79 | −5.52 |
| 6 | PVOH, 4 pph tetra OBA | 99.6 | 110.4 | 97.1 | −0.38 | −3.98 |
| 7 | Polyglycerol, 1 pph tetra OBA | 98.9 | 113.9 | 96.8 | 1.32 | −4.96 |
| 8 | Polyglycerol, 2 pph tetra OBA | 100.7 | 118.2 | 96.9 | 1.45 | −5.87 |
| 9 | Polyglycerol, 4 pph tetra OBA | 102.5 | 121.9 | 97.1 | 1.33 | −6.63 |
| 10 | Control, 1 pph hexa OBA | 95.0 | 102.5 | 96.5 | 0.63 | −2.52 |
| 11 | Control, 2 pph hexa OBA | 96.3 | 105.9 | 96.6 | 0.70 | −3.22 |
| 12 | Control, 4 pph hexa OBA | 97.6 | 108.0 | 96.8 | 0.53 | −3.64 |
| 13 | PVOH, 1 pph hexa OBA | 99.1 | 115.2 | 96.7 | 1.49 | −5.29 |
| 14 | PVOH, 2 pph hexa OBA | 101.0 | 119.6 | 96.8 | 1.45 | −6.20 |
| 15 | PVOH, 4 pph hexa OBA | 101.5 | 117.9 | 97.1 | 0.61 | −5.68 |
| 16 | Polyglycerol, 1 pph hexa OBA | 97.1 | 109.2 | 96.6 | 1.15 | −3.98 |
| 17 | Polyglycerol, 2 pph hexa OBA | 99.8 | 116.5 | 96.8 | 1.49 | −5.51 |
| 18 | Polyglycerol, 4 pph hexa OBA | 102.3 | 122.7 | 97.0 | 1.72 | −6.85 |

L*, a*, and b* are colorimetric values used to describe the shade of a material in color space.
L* is a measure of lightness, and values range from 0 (absolute black) to 100 (absolute white).
Positive a* values indicate redness and negative a* values indicate greenness.
Positive b* values represent yellowness, and negative b* values represent blueness.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments described herein and incorporated herein.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), end ending with a maximum value of 10 or less, (e.g. 2.3 to 9.4, 3 to 8, 4 to 7), and finally to each number 1, 2, 3, 4, 5, 6, 7, 8, 9, and 10 contained within the range.

The above disclosure is intended to be illustrative and not exhaustive. This description will suggest many variations and alternatives to one of ordinary skill in his art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for increasing the brightness and/or whiteness of an OBA containing coating of a paper substrate comprising the step of:
applying to a paper substrate a composition, the composition comprising:
at least one glycerol based polymer and at least one OBA.

2. The method of claim 1 wherein the OBA is selected from the list consisting of: tetrasulfonated stilbene dye or pigment, hexasulfonated stilbene dye or pigment, disulfonated stibene dye or pigment, distryl biphenyl dyes or pigments, other dyes or pigments applicable for the method and any combination thereof.

3. The method of claim 1 wherein the glycerol based polymer is selected from the list consisting of: polyglycerols, polyglycerol derivatives, a polymer consisting of glycerol monomer units and at least another monomer units to other multiple monomers units, and any combination thereof.

4. The method of claim 1 wherein the glycerol based polymer has a structure selected from the list consisting of: linear, branched, hyperbranched, dendrimeric, cyclic and any combination thereof.

5. The method of claim 1 wherein the composition further comprises calcium carbonate.

6. The method of claim 5 wherein the calcium carbonate is GCC.

7. The method of claim 1 wherein the amount of the glycerol based polymer is equal to 1 to 10 pph of the solid portion of the coating formulation.

8. The method of claim 1 in which the glycerol based polymer has a molecular weight range of between 1,000 and 15,000 Daltons.

9. The method of claim 1 in which the substrate has a density of between 20-200 g/m².

10. The method of claim 1 in which the applied composition has a density of between 2-80 g/m².

11. The method of claim 1 in which the composition further comprises one item selected from the list consisting of: water, solvent, organic acids or salt forms, carboxymethyl cellulose, soy protein, starch, sodium alginate, SBA, PVOH, acid functional group based polymers, nonionic polysaccharides, polyalkene derivatives of stilbene, sizing agent, titanium dioxide, ATH, clay, dispersants, cross-linking reagents, biological control reagents, and any combination thereof.

12. The method of claim 1 wherein the amount of the optical brightening agent (OBA) is equal to 0.1-6 pph of the solid portion of the coating formulation.

13. The method of claim 1 wherein the composition coats the paper substrate.
